(19) United States
(12) Patent Application Publication
(10) Pub. No.: US 2007/0141542 A1
(43) Pub. Date: Jun. 21, 2007

(54) Device for teaching a proper elbow position

(76) Inventor: Jack Gershfeld, Fullerton, CA (US)

Correspondence Address: VLADIMIR KHITERER;KHITERER LAW OFFICE, 2109 W. COAST HWY., SUITE 200, NEWPORT BEACH, CA, 92663, US

(21) Appl. No.: 11/304,458

(22) Filed: Dec. 16, 2005

(51) Int. Cl. G09B 19/00

(52) U.S. Cl. 434/250

(57) ABSTRACT

A device for teaching a proper elbow position is disclosed. The device comprises a lever and a base member connected by a spring loaded hinge. The lever is attached to an elbow of a student and the base member abuts against a rib cage of the student. Also provided is an alarm means engaging when the student lowers his elbow, prompting the student to correct the elbow position.

### BACKGROUND OF THE INVENTION

Practicing and dancing Waltz, Foxtrot, Tango or Viennese Waltz presents a specific challenge for a male leading dance partner of maintaining his right elbow perfectly aligned with respect to the body. When a male dancer stands upright, his right elbow must be at substantially 90 degrees relative to his ribcage. This alignment should be maintained throughout various dance moves, even when the body is not upright. Due to muscle fatigue, dancers tend to lower their elbows, thus losing the elbow to body alignment.

Conventionally, a dance teacher would prompt a dancer to lift up the elbow and reestablish the alignment. Alternatively, the dancer may view himself in a mirror and adjust his elbow position when needed. Over many hours of correct practice, hand and shoulder muscle memory will develop, helping the dancer to sense whether the proper elbow position is maintained.

It is important that correct practice techniques are used to make sure proper muscle memory is developed. A feedback from teachers or mirrors to maintain proper elbow position is not always available and may not be objective. Most dance students struggle to maintain proper elbow position and are in need of constant reminder to keep their elbow up.

Also, music students learning to play a violin face identical challenge with an opposite elbow. In this situation, the left elbow must be in the proper position to maintain optimum reach to strings and to achieve high speed of playing.

What is needed is a device that allows various students to have an objective means to alert them when their elbow drops bellow the predetermined angle and allows them to develop a good habit of keeping their elbow in the correct position.

### SUMMARY OF THE INVENTION

The present invention satisfies the above need. Specifically, the device for teaching proper elbow position according to the present invention comprises a lever and a base member connected by a spring loaded hinge. The lever is attached to an elbow of a student and the base member abuts against the rib cage of the student. Also provided is an alarm means engaging when the student lowers his elbow, causing the angle between the lever and the base member to be less than a predetermined angle.

### BRIEF DESCRIPTION OF THE DRAWINGS FIGURES

FIG. 1 shows the isometric view of the device according to the present invention;

FIG. 2 shows the device according to the present invention worn by a dancer while standing upright and maintaining his elbow in proper alignment relative to his rib cage;

FIG. 3 shows the device according to the present invention worn by a dancer while standing upright and not maintaining his elbow in proper alignment relative to his rib cage;

FIG. 4 shows the device according to the present invention worn by a dancer while leaning to the right and maintaining his elbow in proper alignment relative to his rib cage;

FIG. 5 shows the isometric view of the alternative embodiment of the device according to the present invention;

FIG. 6 shows the portion of the alternative embodiment of the device according to the present invention.

### DETAILED DESCRIPTION OF THE PREFERRED EMBODIMENT

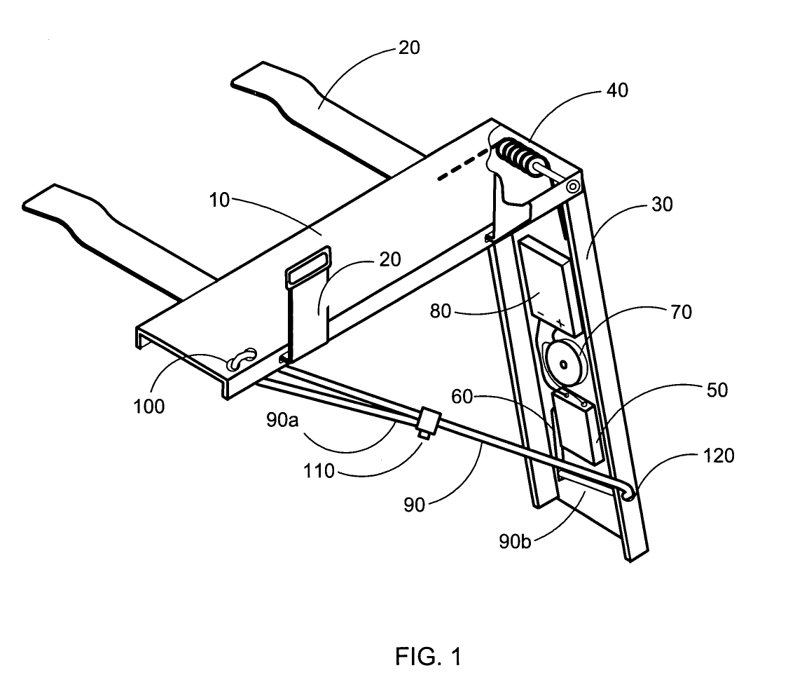

This invention will be better understood with the reference to the drawing figures FIG. 1-FIG. 6. The same numerals and/or letters refer to the same elements in all drawing figures.

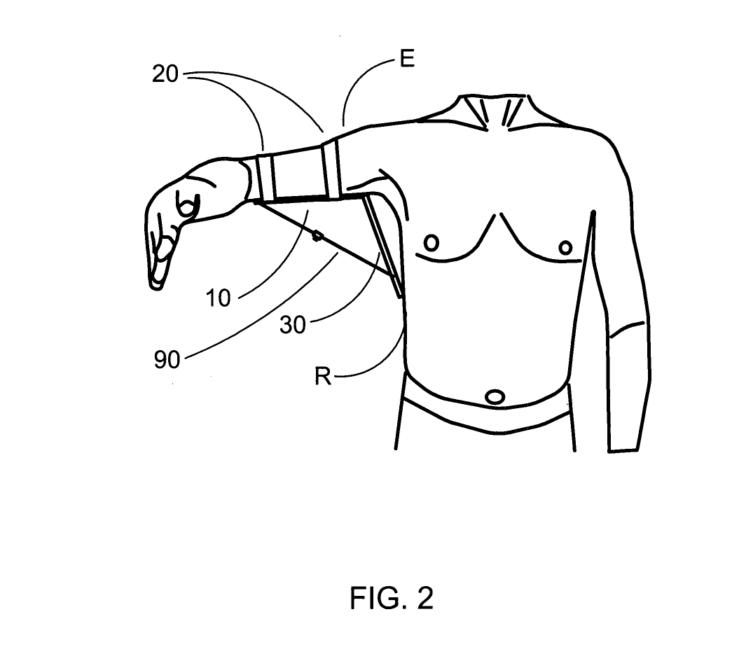

Viewing simultaneously FIG. 1 and FIG. 2, numeral 10 indicates a lever. Lever 10 is attached to an elbow of a dancer, indicated by letter E, by a means of attachment indicated by numeral 20. Means of attachment 20 are disposed on lever 10 and shown in FIG. 1 and FIG. 2 as adjustable straps disposed substantially perpendicularly to the longitudinal axis of lever 10. At least one such adjustable strap is required to secure lever 10 to elbow E.

Numeral 30 indicates a base member. Base member 30 abuts against a rib cage of the dancer indicated by letter R. Numeral 40 indicates a hinge means. Hinge means 40 pivotally connects lever 10 to base member 30 while biasing lever 10 away from base member 30. Hinge means 40 is shown in FIG. 1 as a spring loaded hinge, however, any means of biasing lever 10 away from base member 30 may be employed.

Also provided is an angle fixing means defining a desired angle between lever 10 and base member 30 and an alarm means engaging when an angle between lever 10 and base member 30 is less than the desired angle, i.e. when the dancer lowers his elbow and loses the proper alignment. Viewing FIG. 1, the alarm means comprises a switch indicated by numeral 50, a buzzer indicated by numeral 60 and a battery indicated by numeral 80.

Switch 50 can be selectively placed in an “on” position and in an “off” position by a spring loaded actuator indicated by numeral 60. Spring loaded actuator 60 is biased towards the “on” position such that pulling on spring loaded actuator 60 causes switch 50 to remain in the “off” position.

Battery 80 is electrically coupled to switch 50 and buzzer 70. Battery 80 energizes buzzer 70 when switch 50 is placed in the “on” position. Buzzer 70 can be a piezoelectric means, an electromechanical means, a speaker means, a vibrator means or any means known to the people knowledgeable in the pertinent arts to be suitable for producing audible or vibrating alert. An earphone output (not shown) may also be provided for connecting earphones to act as buzzer 70.

Still viewing FIG. 1, the angle fixing means comprises a string indicated by numeral 90. String 90 comprises a proximate end indicated by numeral 90a and a distal end indicated by numeral 90b. Distal end 90b is fixedly attached to actuator 60.

Numeral 100 indicates an eyelet. Eyelet 100, disposed in lever 10, is receiving proximate end 90a and passing a loop of string 90 through eyelet 100. Numeral 110 indicates a friction lock. Friction lock 110 is slideably disposed on string 90. Proximate end 90a is fixedly attached to friction lock 110.

Friction lock 110 can be placed in an open position and in a closed position. When friction lock 110 is placed in the open position, it slides freely along string 90. When friction lock 110 is placed in the closed position, it affixes proximate end 90a on a selected position on string 90 for selecting the desired angle. Maintaining such desired angle causes distal end 90b to pull on actuator 60, thus maintaining switch 50 in the “off” position (and buzzer 70 silent).

Numeral 120 indicates an opening. Opening 120 is disposed on base member 30 and receives distal end 90b, passing string 90 through opening 130 for pulling on actuator 60. FIG. 1 shows only one opening 130, however, a number of openings 130 can be employed for passing string 90 through for pulling on actuator 60.

Viewing now FIG. 2, elbow E is maintained in a proper alignment causing lever 10 to maintain the desired angle with respect to base member 30. This causes string 90, which had been adjusted by sliding and fixing friction lock 110, to be fully tensioned. String 90, in fully tensioned condition, causes distal end 90b to pull on actuator 60, keeping switch 50 in the “off” position. Accordingly, buzzer 70 stays silent.

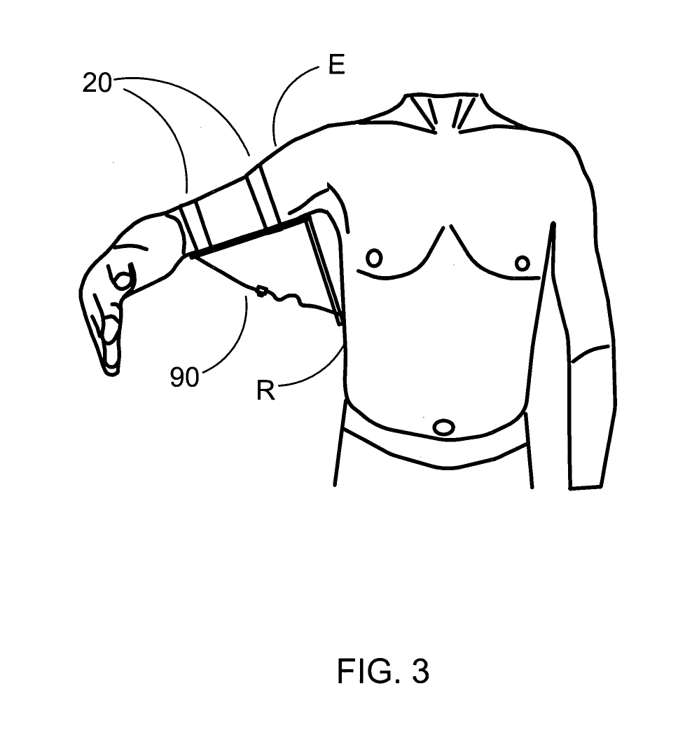

Viewing now FIG. 3, as soon as the dancer lowers elbow E (and loses the proper alignment), string 90 loses its fully tensioned condition. This causes actuator 60 to place switch 50 in the “on” position, energizing buzzer 70. When buzzer 70 produces audible alarm, the dancer will lift up elbow E and reestablish the proper alignment, in which case buzzer 70 will be turned off due to pulling on actuator 60.

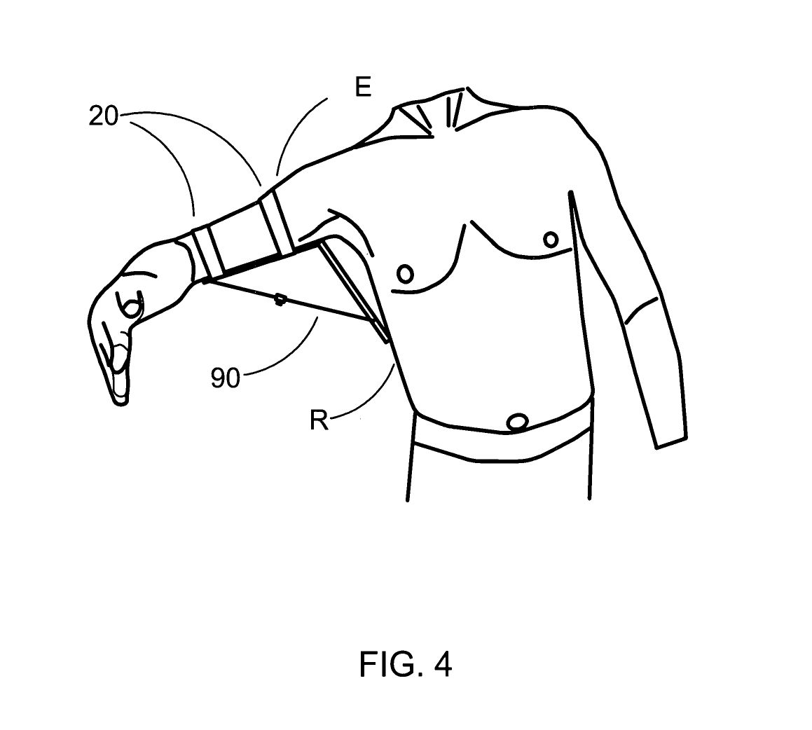

Viewing now FIG. 4, the dancer is shown leaning to the right and maintaining elbow in proper alignment. Accordingly, string 90 is in a fully tensioned condition and buzzer 70 is silent. Ideally, the dancer will maintain buzzer 70 silent throughout various dance moves. Over time, muscle memory will develop and the dancer will be able to maintain his elbow in proper alignment without the device of this invention. From time to time this device can be used to reinforce proper elbow placement.

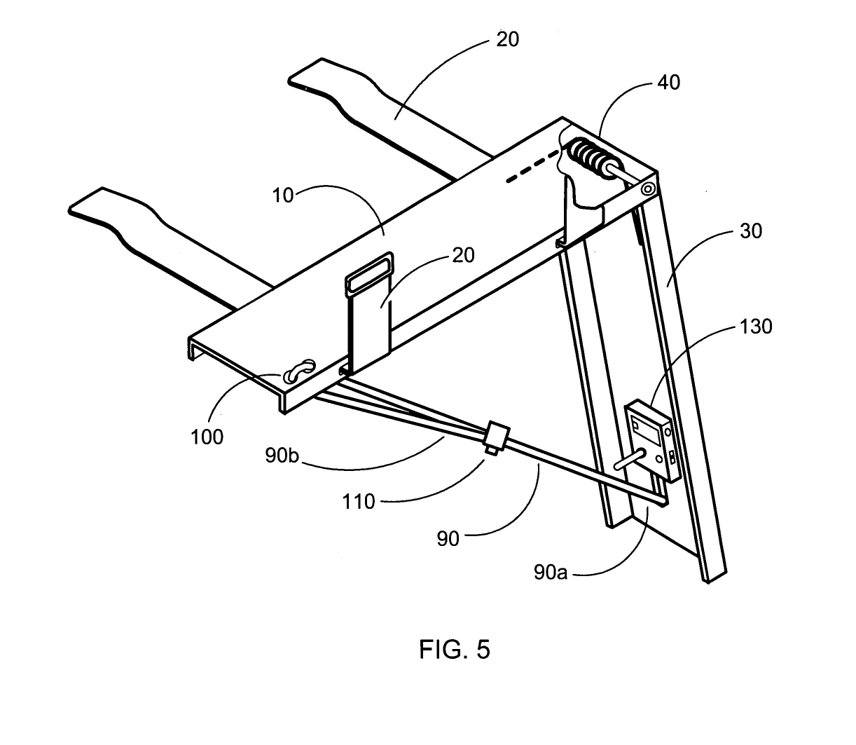

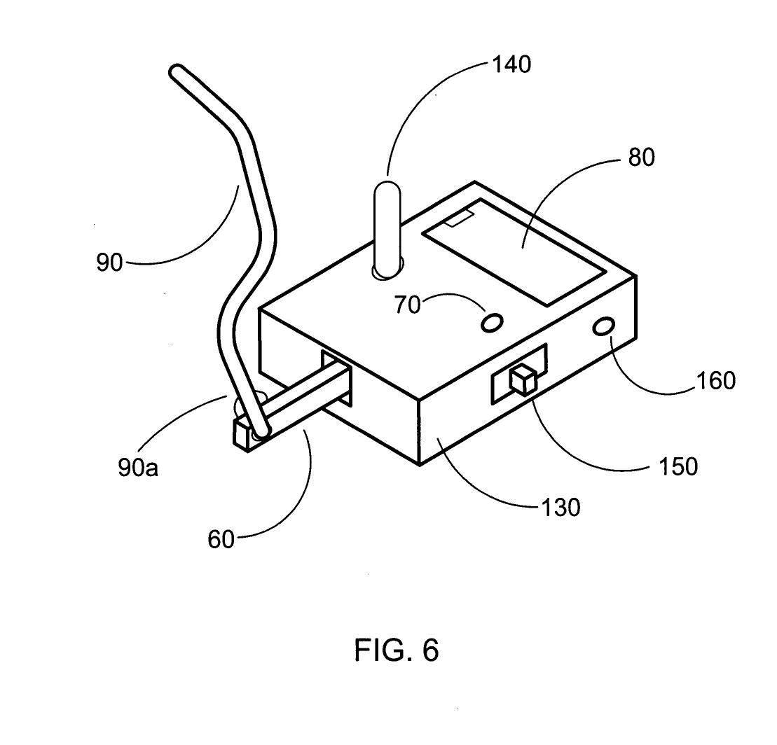

Viewing now FIG. 5, an alternative embodiment of this invention differs from the embodiment shown in FIG. 1 in that enclosure indicated by numeral 130 houses switch 50, buzzer 70 and battery 80. Viewing now FIG. 6, numeral 140 indicates a spring loaded limit switch. Limit switch 140 is disposed on enclosure 130. Limit switch 140 engages with lever 10 when lever 10 pivots to a predetermined distance towards base member 30, disconnecting buzzer 70 from battery 80 when engaged. The purpose of limit switch 140 is to allow the dancer to rest when lowering elbow E down without buzzer 70 producing audible alarm.

Still viewing FIG. 6, numeral 150 indicates a selector. Selector 150 is disposed on enclosure 130. Selector 150 can place buzzer 70 in a vibration mode and a sound mode according to the dancer's preference. Numeral 160 indicates an earphone output. Earphone output 160 is disposed on enclosure 130 and allows connecting earphones to act as buzzer 70.

Persons knowledgeable in the pertinent arts will recognize that even though the embodiments of this invention are described in FIG. 1-FIG. 6 in reference to a dancer, they can be used by a student learning to play a violin by simply attaching the lever of this invention to the left elbow.

While the present invention has been described and defined by references to the preferred embodiments of the invention, such references do not imply a limitation on the invention, and no such limitation is to be inferred. The invention is capable of considerable modification, alteration, and equivalents in form and function, as will occur to those ordinarily skilled and knowledgeable in the pertinent arts. The depicted and described preferred embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A device for teaching a proper elbow position, comprising:
a lever attached to an elbow of a student by a means of attachment disposed on the lever;
a base member abutting against a rib cage of the student;
a hinge means pivotally connecting the lever to the base member and biasing the lever away from the base member;
an angle fixing means defining a desired angle between the lever and the base member;
an alarm means engaging when an angle between the lever and the base member is less than the desired angle.

2. A device for teaching a proper elbow position as in claim 1, wherein the means of attachment comprises at least one adjustable strap disposed substantially perpendicularly to the longitudinal axis of the lever and wherein the hinge means is a spring loaded hinge.

3. A device for teaching a proper elbow position as in claim 2, wherein the alarm means comprises:
a switch that can be selectively placed in an “on” position and in an “off” position by a spring loaded actuator biased towards the “on” position;
a buzzer;
a battery electrically coupled to the switch and the buzzer, the battery energizing the buzzer when the switch is placed in the “on” position;

4. A device for teaching a proper elbow position as in claim 3, wherein the angle fixing means comprises:
a string comprising a proximate end and a distal end, the distal end fixedly attached to the actuator;
an eyelet disposed in the lever receiving the proximate end and passing a loop of the string through the eyelet, the proximate end fixedly attached to a friction lock slideably disposed on the string;
wherein the friction lock can be placed in an open position and in a closed position;
wherein the friction lock placed in the open position sliding freely along the string;
wherein the friction lock placed in the closed position affixing the proximate end on a selected position on the string for selecting the desired angle;
wherein maintaining the desired angle causing the distal end to pull on the actuator maintaining the switch in the “off” position.

5. A device for teaching a proper elbow position as in claim 4, wherein the base member further comprises at least one opening receiving the distal end and passing the string through the opening for pulling on the actuator.

6. A device for teaching a proper elbow position as in claim 5, wherein the buzzer is selected from the group consisting of a piezoelectric means, an electromechanical means, a speaker means and a vibrator means.

7. A device for teaching a proper elbow position as in claim 6, wherein the alarm means further comprises an earphone output.

8. A device for teaching a proper elbow position, comprising:
(a) a lever attached to an elbow of a student by at least one adjustable strap disposed substantially perpendicularly to the longitudinal axis of the lever;
(b) a base member abutting against a rib cage of the student;
(c) a spring loaded hinge pivotally connecting the lever to the base member and biasing the lever away from the base member;
(d) an alarm means engaging when an angle between the lever and the base member is less than the desired angle comprising:
a switch that can be selectively placed in an “on” position and in an “off” position by a spring loaded actuator biased towards the “on” position;
a buzzer selected from the group consisting of a piezoelectric means, an electromechanical means, a speaker means and a vibrator means;
a battery electrically coupled to the switch and the buzzer, battery energizing the buzzer when the switch is placed in the “on” position;
wherein the battery, the buzzer and the switch are housed in one enclosure;
(e) an angle fixing means defining a desired angle between the lever and the base member, comprising:
a string comprising a proximate end and a distal end, the distal end fixedly attached to the actuator;
an eyelet disposed in the lever receiving the proximate end and passing a loop of the string through the eyelet, the proximate end fixedly attached to a friction lock slideably disposed on the string;
wherein the friction lock can be placed in an open position and in a closed position;
wherein the friction lock placed in the open position sliding freely along the string;
wherein the friction lock placed in the closed position affixing the proximate end on a selected position on the string for selecting the desired angle;
wherein maintaining the desired angle causing the distal end to pull on the actuator maintaining the switch in the “off” position.

9. A device for teaching a proper elbow position as in claim 8, wherein the base member further comprises at least one opening receiving the distal end and passing the string through the opening for pulling on the actuator.

10. A device for teaching a proper elbow position as in claim 9, wherein the alarm means further comprises a spring loaded limit switch disposed on the enclosure engaging with the lever when the lever pivots to a predetermined distance towards the base member, disconnecting the buzzer from the battery.

11. A device for teaching a proper elbow position as in claim 10, wherein the buzzer can be selectively placed in a vibration mode and in a sound mode by a selector disposed on the enclosure.

12. A device for teaching a proper elbow position as in claim 11, wherein the alarm means further comprises an earphone output disposed on the enclosure.
